(19) United States
(12) Patent Application Publication
(10) Pub. No.: US 2026/0200377 A1
(43) Pub. Date: Jul. 16, 2026

(54) CHILD CAR SEAT WITH ROTATIONAL LOCK

(71) Applicant: Evenflo Company, Inc., Miamisburg, OH (US)

(72) Inventor: Bryan Ray Adams, Beavercreek, OH (US)

(21) Appl. No.: 19/022,738

(22) Filed: Jan. 15, 2025

(51) Int. Cl. B60N 2/28; B60N 2/90

(52) U.S. Cl. CPC B60N 2/2869; B60N 2/2821; B60N 2002/952

(57) ABSTRACT

Disclosed herein is a rotatable car seat comprised of a base and a seat shell, where the seat shell is rotatable with respect to the base. The base includes a receiving portion having a receiving cavity surface including primary positioning cavities at the front and rear end of the base and secondary positioning cavities at a first and second side of the base. The primary positioning cavities have a greater depth than the secondary positioning cavities and a lesser angle with respect to the receiving cavity surface such that a rotation locking arm is locked within the primary positioning cavity and cannot be moved without actuation of an external mechanism that moves the rotation locking arm.

### BACKGROUND

In the United States, child car seats are required by law and recommended for children of certain ages or sizes. There are many types of car seats available for purchase. Infant car seats recommended for children under age one are typically rearward facing relative to the vehicle in which they are installed. Many infant car seats include a base that is belted, latched, or tethered into the car and a seat that may latch into the base. A popular car seat option for infants as well as children is a “convertible” car seat that may be oriented in a rear-facing position and then “converted” to a front-facing position for accommodating older children.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a view of a car seat system in accordance with aspects herein;

FIG. 2 is an exploded side view of the car seat of FIG. 1, in accordance with aspects herein;

FIG. 3 is a view of a base of FIG. 2, in accordance with aspects herein;

FIG. 4 is a front view of the base of FIG. 2, in accordance with aspects herein;

FIG. 5 is a rear view of the base of FIG. 2, in accordance with aspects herein;

FIG. 6 is a side view of the base of FIG. 2, in accordance with aspects herein;

FIG. 7 is a side view of the base of FIG. 2, in accordance with aspects herein;

FIG. 8 is a top-down view of the base of FIG. 2, in accordance with aspects herein;

FIG. 9 is a view of the base of FIG. 2, in accordance with aspects herein;

FIG. 10A is a close-up view of a primary positioning cavity of the base of FIG. 2, in accordance with aspects herein;

FIG. 10B is a cross-section view of the primary positioning cavity of FIG. 10A, in accordance with aspects herein;

FIG. 11A is a close-up view of a secondary positioning cavity of the base of FIG. 2, in accordance with aspects herein;

FIG. 11B is a cross-section view of the secondary positioning cavity of FIG. 11A, in accordance with aspects herein;

FIG. 12A is a side view of the seat shell of FIG. 2, in accordance with aspects herein;

FIG. 12B is a close-up view of the rotation locking arm of the seat shell of FIG. 12A, in accordance with aspects herein;

FIG. 13 is a close-up view of the rotation locking arm engaged with a primary positioning cavity of the base of FIG. 2, in accordance with aspects herein;

FIG. 14A is a close-up view of the rotation locking arm engaged with a secondary positioning cavity of the base of FIG. 2, in accordance with aspects herein;

FIG. 14B is a close-up view of the rotation locking arm disengaging with a secondary positioning cavity of the base of FIG. 2, in accordance with aspects herein;

FIG. 15A is a cross-section view of the rotation locking arm engaged with a primary positioning cavity of the base of FIG. 2, in accordance with aspects herein;

FIG. 15B is a cross-section view of the rotation locking arm disengaged with a primary positioning cavity of the base of FIG. 2, in accordance with aspects herein;

FIG. 16A is a cross-section view of the rotation locking arm engaged with a secondary positioning cavity of the base of FIG. 2, in accordance with aspects herein; and

FIG. 16B is a cross-section view of the rotation locking arm disengaged with a secondary positioning cavity of the base of FIG. 2, in accordance with aspects herein;

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

Juvenile car seats, as will be discussed below in greater detail, provide a secure seating option for children in a vehicle. A juvenile car seat may be able to rotate relative to a base secured to the vehicle. The rotation of a seat portion relative to the base allows the seat to be forward facing, rearward facing, and at intermediate positions there between.

Because of the rotatable nature of some juvenile car seats, a child occupant may be loaded into either a forward-facing orientation or a rear-facing orientation from a loading position (i.e., when a front of the juvenile car seat faces an outward position toward a door of a vehicle). In this way, an adult or other individual loading a child into the juvenile car seat can easily load the occupant into the juvenile car seat from a loading position facing the individual loading the child into the seat instead of trying to load the juvenile seat occupant at a side angle while the juvenile car seat is facing a forward-facing or rear-facing orientation.

However, the ease of loading a child occupant from a loading position also accompanies additional force and effort required to move the juvenile car seat to and from a loading position to/from the forward-facing and/or rear-facing orientation while also introducing a structure for the rotatable seat shell to move out of a locking position (e.g., the forward-facing or rear-facing orientation). An ability to easily navigate to and from a loading position while also maintaining adequate securement in a locked position (i.e., forward-facing or rear-facing orientation) is desired.

As will be provided in greater detail hereinafter, the following disclosure provides positioning cavities within a receiving portion of the base of the juvenile car seat. The positioning cavities include primary positioning cavities and secondary positioning cavities. The primary positioning cavities are “locking” cavities that are placed at a first location (e.g., a front end) and a second, opposite, location (e.g., a rear end) of the base and serve as a structure to lock the seat shell into either a forward-facing or rear-facing orientation. The primary positioning cavities comprise a first side wall and a second side wall that are at a first angle relative to the receiving portion of the base such that a rotation locking arm within the primary positioning cavities locks (e.g., resists rotational movement) the seat shell into place and is only displaced upon actuation of a handle to remove the rotation locking arm from the primary positioning cavities.

The secondary positioning cavities are “non-locking” cavities that are placed at a third location (e.g., a first side) and a fourth location (e.g., a second side) of the base of the juvenile car seat. The secondary positioning cavities comprise a first side wall and a second side wall that are at a second angle relative to the receiving portion of the base. The second angle of the secondary positioning cavities is lesser than the first angle of the primary positioning cavities. The second angle is positioned such that the rotation locking arm within the secondary positioning cavities is intentionally displaced from the secondary positioning cavities with only external rotational force of a user. In other words, no actuation of a handle to move the rotation locking arm is needed to cause rotation of the juvenile car seat when the rotation locking arm engages with the secondary positioning cavities. The force of a user moving the juvenile car seat in a rotational direction toward either the front end or the rear end of the base is sufficient to displace the rotation locking arm from the secondary positioning cavities and rotate the seat shell.

Aspects contemplated herein include a rotation locking arm that has a distal portion having an angled surface wall and a more proximal portion having a less angled surface wall. The rotation locking arm extends into the primary locking cavities a sufficient depth so that at least the more proximal portion of the rotation locking arm mechanically interferes with a side wall of a primary positioning cavity. In this configuration, the angles of the surface wall at the more proximal end and the sidewall of the primary positioning cavity resist forced rotation of the seat shell relative to the base. The same locking arm also interacts with a secondary positioning cavity when the seat shell is rotated relative to the base. However, in this rotated position only the distal portion of the rotation locking arm interacts with a sidewall of the secondary positioning cavity. Because the surface wall of the distal portion is angled and the sidewalls of the secondary positioning cavity are angled, with sufficient force the seat shell may rotate relative to the base by causing the distal portion of the rotation locking arm to elevate out of the secondary positioning cavity. The elevation results by the inclined surfaces of the distal portion interacting with the inclined surfaces of the sidewall converting rotational force to vertical force. In this way a common rotation locking arm can provide a rotational lock when engaged with the primary positioning cavity and a resistive, but able to be overcome, rotational hold when engaged with the secondary positioning cavity.

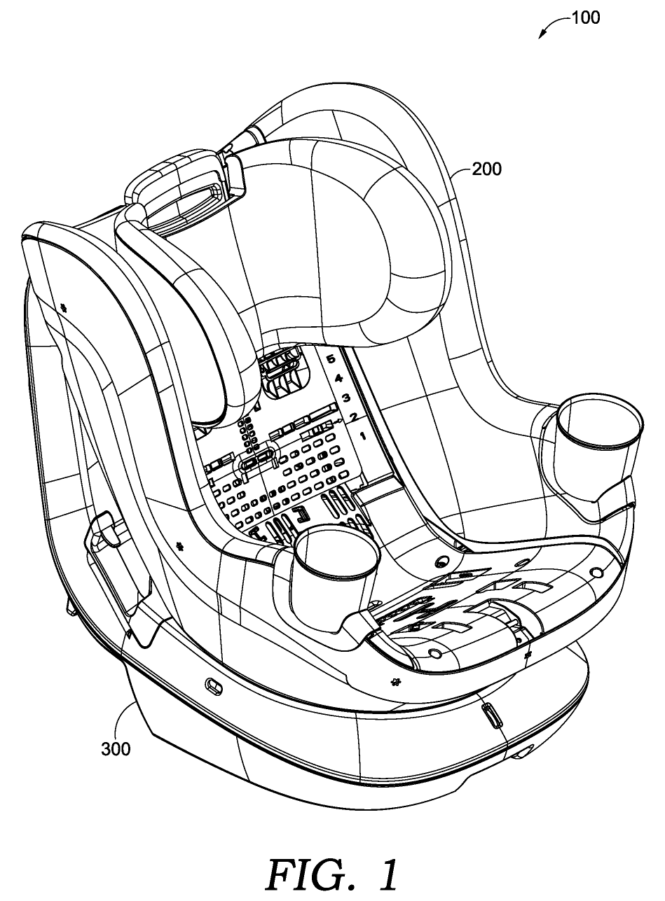

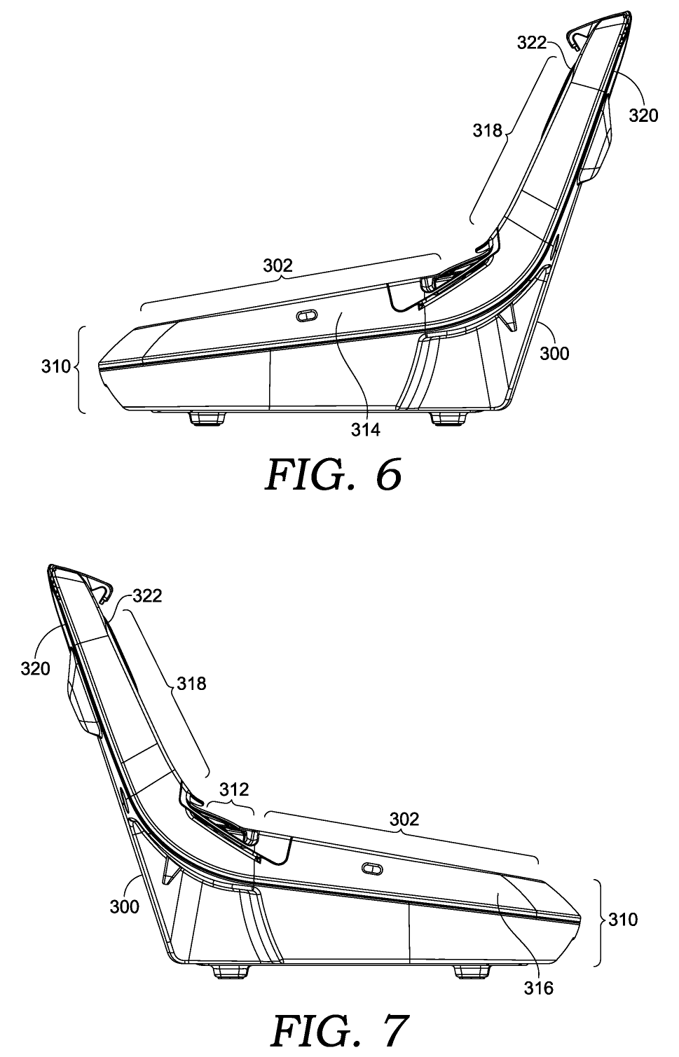

In accordance with aspects of the disclosure, exemplary embodiments of car seats are illustrated in various levels of specificity in FIGS. 1-16B. As will be appreciated by those skilled in the art, the car seats described herein may be convertible car seats that are convertible between a forward-facing configuration and a rearward-facing configuration. The car seats of the present disclosure may be configured to support an infant, child, toddler, or the like. Very generally, car seat 100 is designed for transporting an infant or child in a car. As illustrated in FIG. 1, the car seat 100 generally includes a seat shell 200, which is supported on a base 300. As will be readily understood by those skilled in the art, the car seat 100 (and, namely, the base 300) may be affixed to the seat of a car, such as by a seat belt (e.g., lap belt) of the car, a tether, or other latching mechanism.

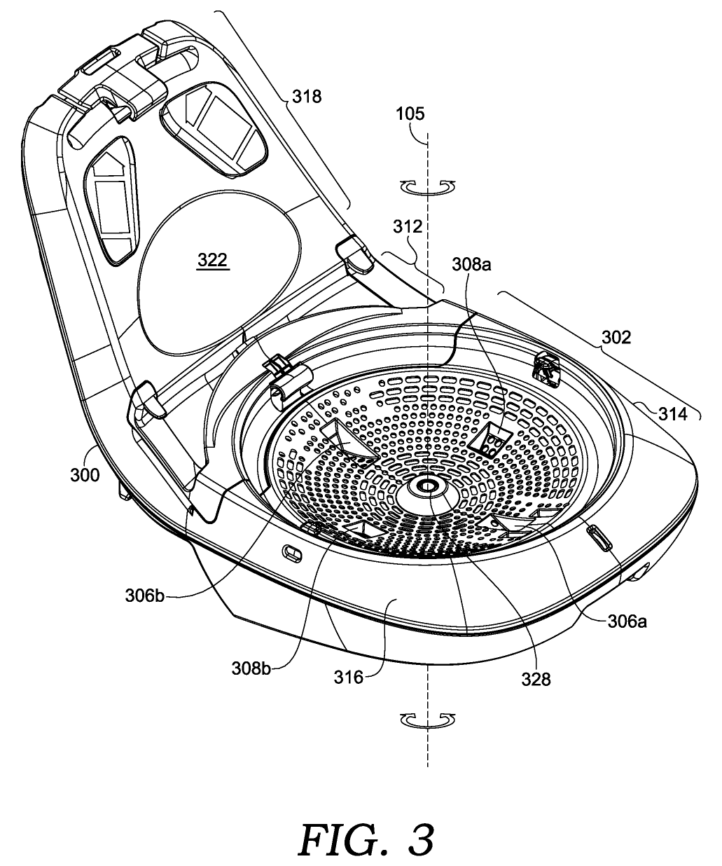

As described in more detail herein, the seat shell 200 may be removably or non-removably attached to the base 300. Additionally, the seat shell 200 may be rotatable with respect to the base 300. The seat shell 200 may be rotated to be selectively positionable in a variety of different positions (e.g., a rearward-facing position, a forward-facing position, an intermediate loading/unloading position). In particular, the seat shell 200 may rotate about an axis 105 (illustrated in FIG. 3) that may be generally vertical. In some examples, the axis 105 is generally vertical while on a slight diagonal such that the angle of the seat shell 200 relative to the vehicle seat may changes as the seat shell 200 is rotated about the axis 105 between forward-facing and rearward-facing positions.

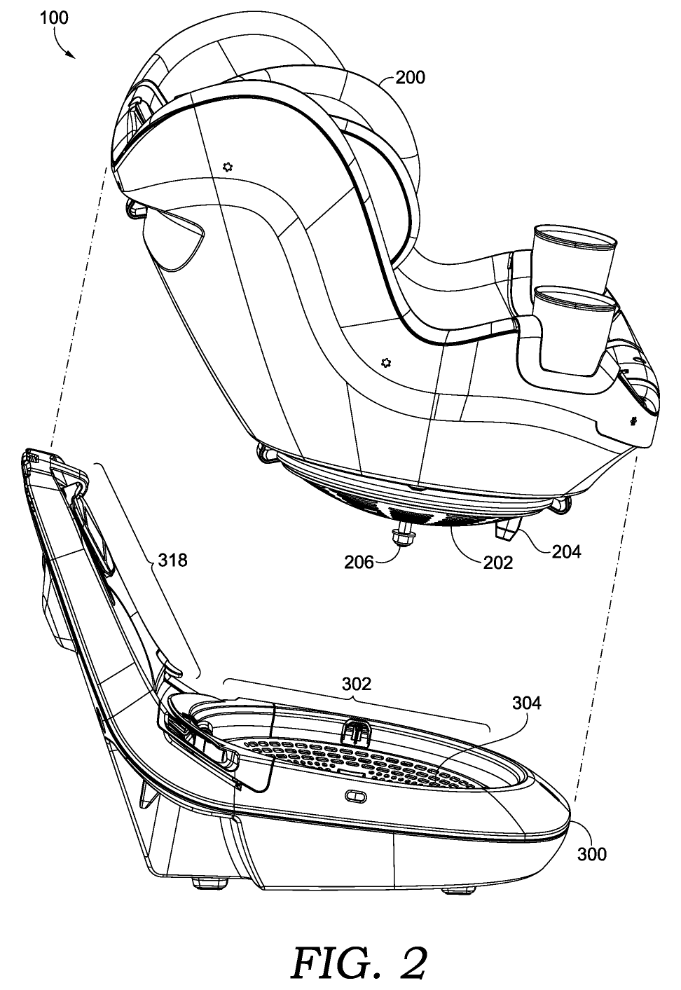

FIG. 2 illustrates an exploded side view of the car seat 100 system including the seat shell 200 and the base 300. The seat shell 200 includes a bottom surface 202 having a rotation locking arm 204 and an engagement feature 206. The base 300 comprises a backing portion 318, a receiving portion 302 for interfacing with the bottom surface 202 of the seat shell 200, and a receiving cavity surface 304. The base also comprises a receiving feature 328 (visible in FIG. 3) for receiving the engagement feature 206 of the seat shell 200 to achieve a non-removable configuration such that the seat shell 200 is non-removable from the base 300. In other aspects, the seat shell 200 is removable from the base 300. In an exemplary embodiment, the receiving portion 302 of the base 300 is curved or concave so as to at least partially define a bowl shape. In this way, the receiving portion 302 of the base 300 generally defines a cavity that is sized and shaped to receive at least a portion of the seat shell 200.

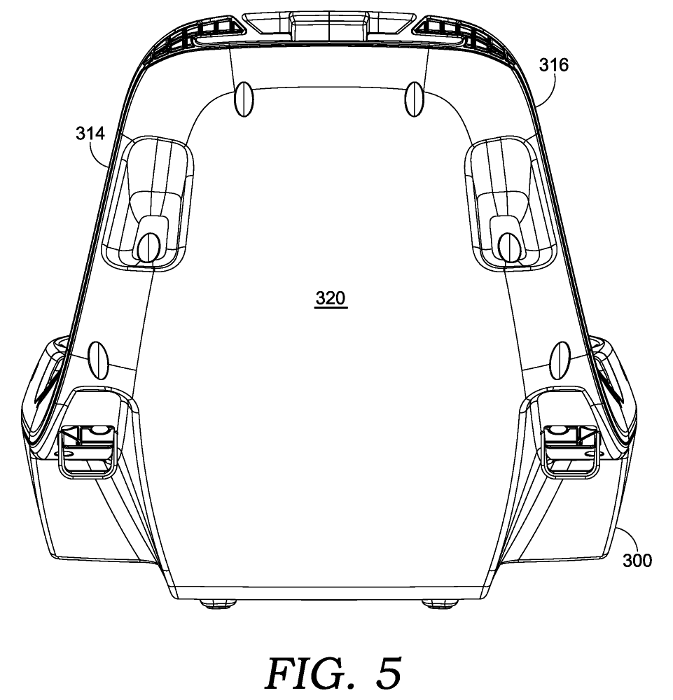

FIG. 3 depicts a view of the base 300 having a backing portion 318 that extends upwardly away from the receiving portion 302, wherein the backing portion 318 comprises a forward surface 322 and a rear surface 320 (visible in FIG. 5). The base 300 further comprises a forward end 310 and a rearward end 312. The forward end 310 of the base 300 is facing toward a forward end of a vehicle when installed while the rearward end 312 is facing toward a rear end of a vehicle when installed. The base 300 further comprises a first side 314 and a second side 316.

Continuing on with FIG. 3, the receiving cavity surface 304 comprises primary positioning cavities 306 and secondary positioning cavities 308. The primary positioning cavities 306, shown as first primary positioning cavity 306a and second primary positioning cavity 306b, are “locking” cavities. The first primary positioning cavity 306a is located at the forward end 310 of the base 300 while the second primary positioning cavity 306b is located at the rearward end 312 of the base 300. The primary positioning cavities 306 lock the rotation locking arm 204 within the primary positioning cavities 306 until actuation of a handle (or other mechanism) to move the rotation locking arm 204 such that it can exit the primary positioning cavities 306. While the primary positioning cavities are shown at the forward and rearward ends, it is contemplated that they may be positioned at any radial location of the base. In an example, two primary cavities are positioned directly opposite each other, regardless of where they are radially positioned. This direct opposition positioning, in an example, allows for a common rotation locking arm positioned within the seat shell to engage each of the primary locking cavities at a forward and rearward orientation.

The secondary positioning cavities 308, shown as first secondary positioning cavity 308a and second secondary positioning cavity 308b, are “non-locking” cavities. The secondary positioning cavities 308 hold the rotation locking arm 204 in place in the absence of an external force. Thus, the rotation locking arm 204 is held in place securely enough to load or unload a child occupant into the car seat 100 system, but freely enough such that an external rotational force (from a user) will cause the rotation locking arm 204 to disengage from the secondary positioning cavities 308. While the secondary positioning cavities are shown at the sides, it is contemplated that they may be positioned at any radial location of the base. In an example, two secondary cavities are positioned directly opposite each other, regardless of where they are radially positioned. This direct opposition positioning, in an example, allows for a common rotation locking arm positioned within the seat shell to engage each of the secondary locking cavities at a side-facing orientation.

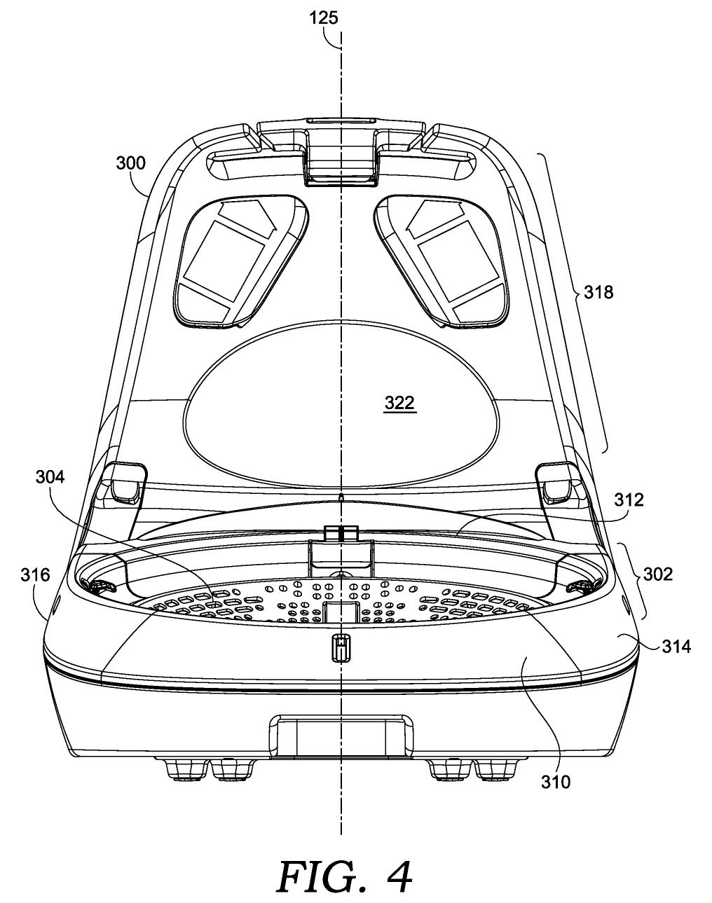

FIGS. 4-7 depict a front view of the base 300 having a reference midline 125, a rear view of the base 300, and first side view of the base 300, and a second side view of the base 300, respectively.

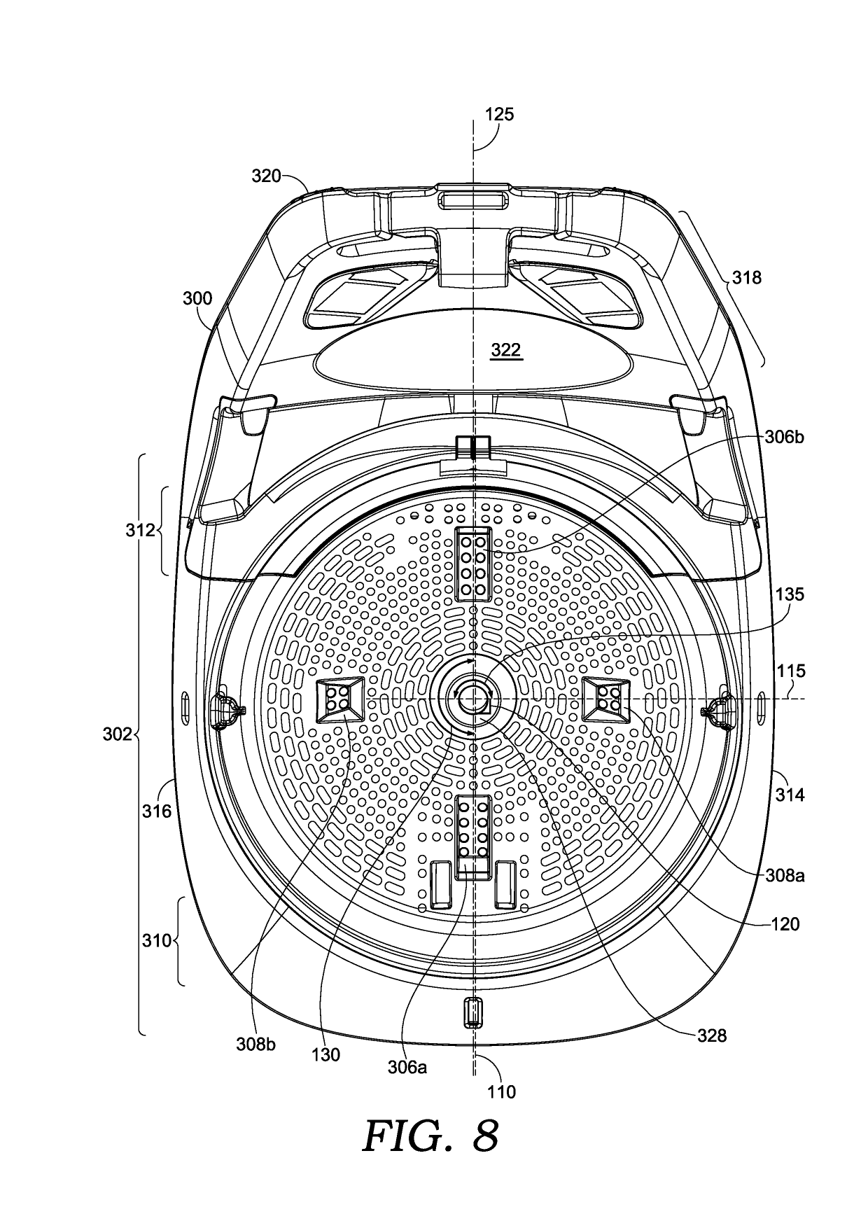

FIG. 8 illustrates a top-down view of the base 300. As is shown, the first primary positioning cavity 306a is at a first radial 110 extending from the rotational axis 105 while the first secondary positioning cavity 308a is at a second radial 115 extending from the rotational axis 105. The first radial 110 and the second radial 115 are offset 90 degrees, as shown by angle 120. The first radial 110 extends through the reference midline 125 at the forward end 310.

Additionally, the first primary positioning cavity 306a and the second primary positioning cavity 306b are offset 180 degrees from each other, relative to the rotational axis 105 and illustrated as angle 130. Furthermore, the first secondary positioning cavity 308a and the second secondary positioning cavity 308b are also offset 180 degrees from each other relative to the rotational axis 105, as shown by angle 135. One of skill can appreciate that the location of the primary and secondary positioning cavities can be located at different points along the rotational axis 105. However, the rotation locking arm 204 of the seat shell 200 would also be adjusted such that the configuration still provides a secure lock within the primary positioning cavities 306 when the car seat 100 is in either a forward or rearward-facing orientation. Thus, the primary positioning cavities 306 and the rotation locking arm 204 would still align in either the forward or rearward-facing orientation, while the secondary positioning cavities 308 and the rotation locking arm 204 would align in an intermediate position (e.g., a loading/unloading position).

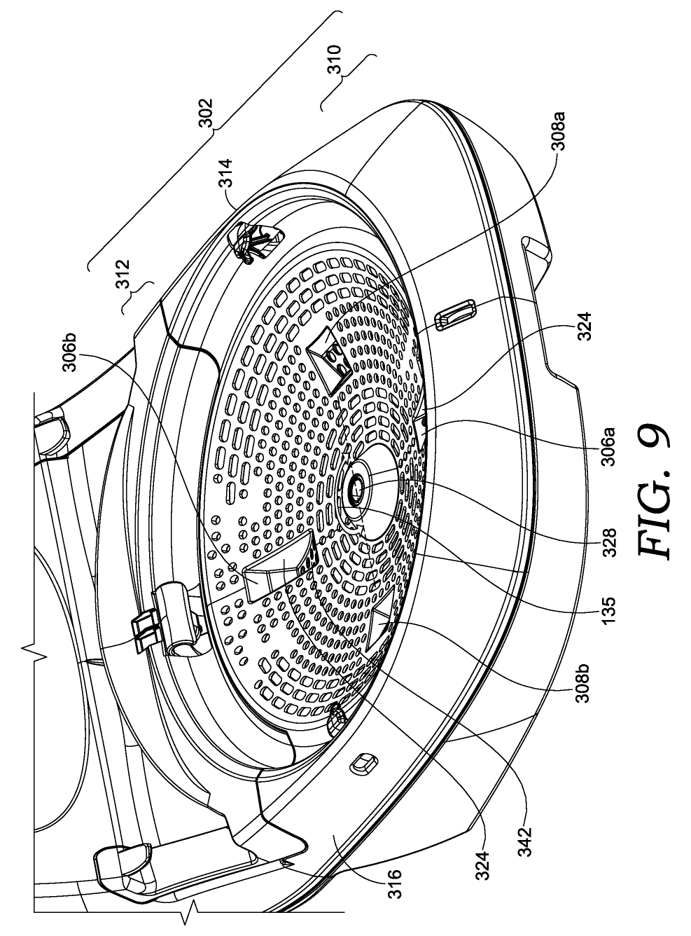

FIGS. 9-11 provide additional views, some close-up, of the base 300 illustrating additional aspects of the primary positioning cavities 306 and the secondary positioning cavities 308. As shown in FIG. 9, the first primary positioning cavity 306a and the second primary positioning cavity 306b have a first side wall 324 and an opposing second side wall 334. Similarly, the first secondary positioning cavity 308a and the second secondary positioning cavity 308b have a first side wall 326 and an opposing second side wall 336.

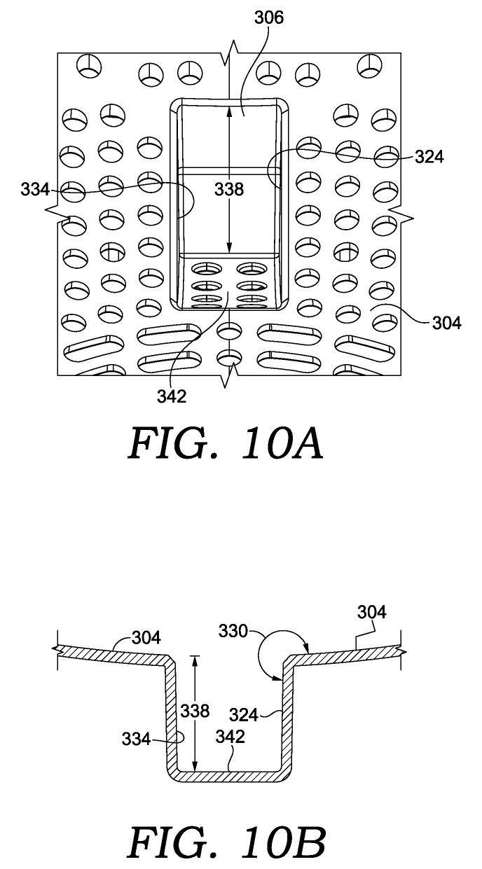

FIG. 10A provides a close-up view of a primary positioning cavity 306. As mentioned, the first side wall 324 and second side wall 334 are opposite one another and identical in structure. The first side wall 324 is in a first rotational directional and the second side wall 334 is in a second rotational direction. The primary positioning cavity 306 has a primary base surface 342 that extends from the first side wall 324 to the second side wall 334. The primary positioning cavity 306 further has a first depth 338 extending from the primary base surface 342 to the receiving cavity surface 304. In aspects, the first depth 338 is at least 25mm. Additionally, as shown by the cross-section view of FIG. 10B, the primary positioning cavities 306 are positioned such that the first side wall 324 has a first angle 330 relative to the receiving cavity surface 304. In aspects, the first angle 330 is greater than 265 degrees. An angle greater than 265 degrees provides sufficient resistance to vertical displacement of a locking arm from the positioning cavity. In aspects, the second side wall 334 shares the same angle with respect to the receiving cavity surface 304 (i.e., the second side wall 334 is also at a first angle 330 with respect to the receiving cavity surface 304).

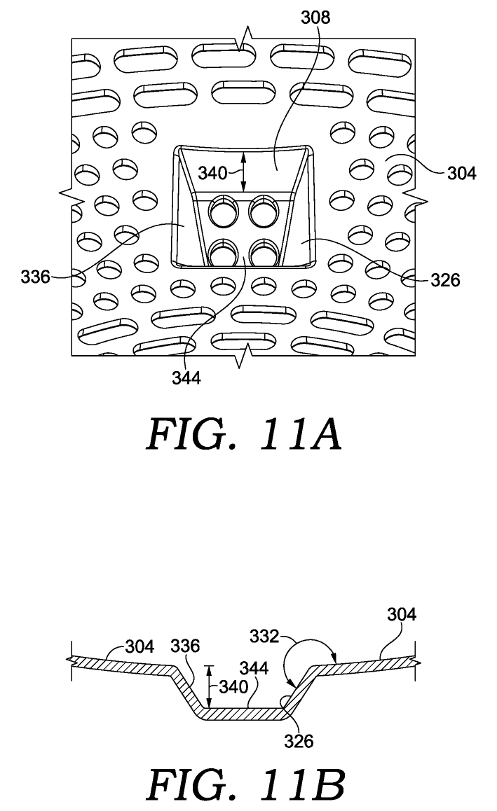

FIG. 11A provides a close-up view of a secondary positioning cavity 308. The secondary positioning cavity 308 has the first side wall 326 and the opposing second side wall 336. The first side wall 326 is in a first rotational direction and the second side wall 336 is in a second rotational direction. The secondary positioning cavity 308 has a secondary base surface 344 extending from the first side wall 326 to the second side wall 336. The secondary positioning cavity 308 has a second depth 340 that extends from the secondary base surface 344 to the receiving cavity surface 304. The second depth 340 of the secondary positioning cavities 308 is less than the first depth 338 of the primary positioning cavities 306. In aspects, as will be discussed below, portions of the rotation locking arm 204 are not contained within the secondary positioning cavities 308 due to the lesser depth of the second depth 340. Furthermore, as illustrated by the cross-section view of FIG. 11B, the secondary positioning cavities 308 are positioned such that the first side wall 326 and the second side wall 336 are at a second angle 332 relative to the receiving cavity surface 304. In aspects, the second angle 332 is less than 260 degrees. An angle less than 260 degrees provides sufficient conversion of rotational force to vertical displacement of a locking arm from the positioning cavity to allow for an intentional vertical displacement of the locking arm. In aspects, the second angle 332 is less than the first angle 330.

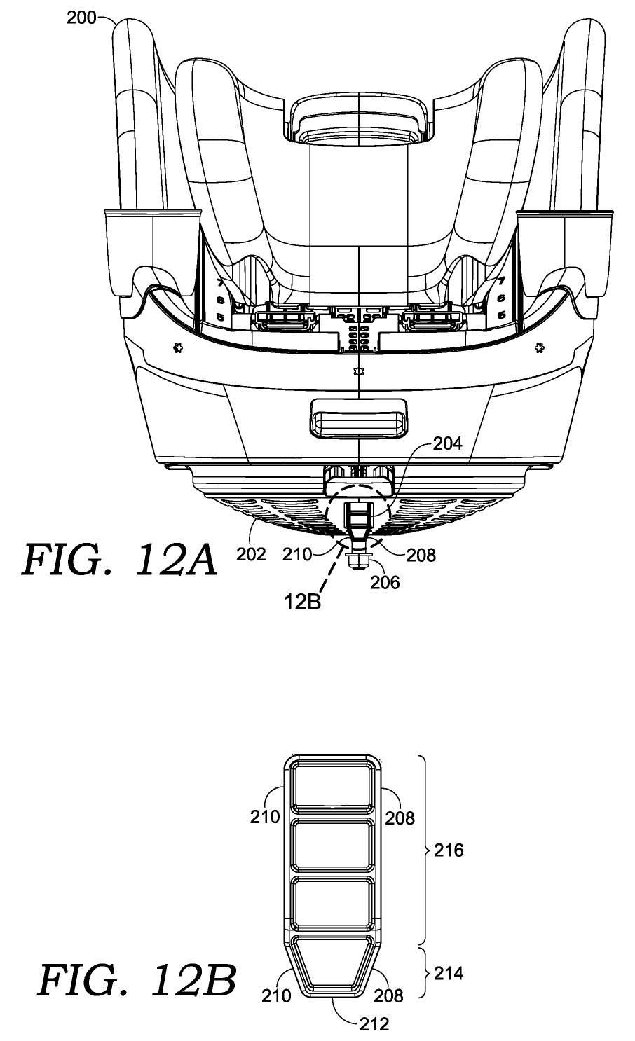

FIG. 12A provides a side view of the seat shell 200 having the rotation locking arm 204 and FIG. 12B provides a close-up view of the rotation locking arm 204. The rotation locking arm has a first portion 214, a second portion 216, a first side 208, a second side 210, and a distal end 212. The first side 208 and the second side 210 are substantially parallel to one another in the second portion 216. The first side 208 and the second side 210 converge in the first portion 214. The distal end 212 extends between the first side 208 and the second side 210. The first portion 214 extends from the distal end 212 to the second portion 216.

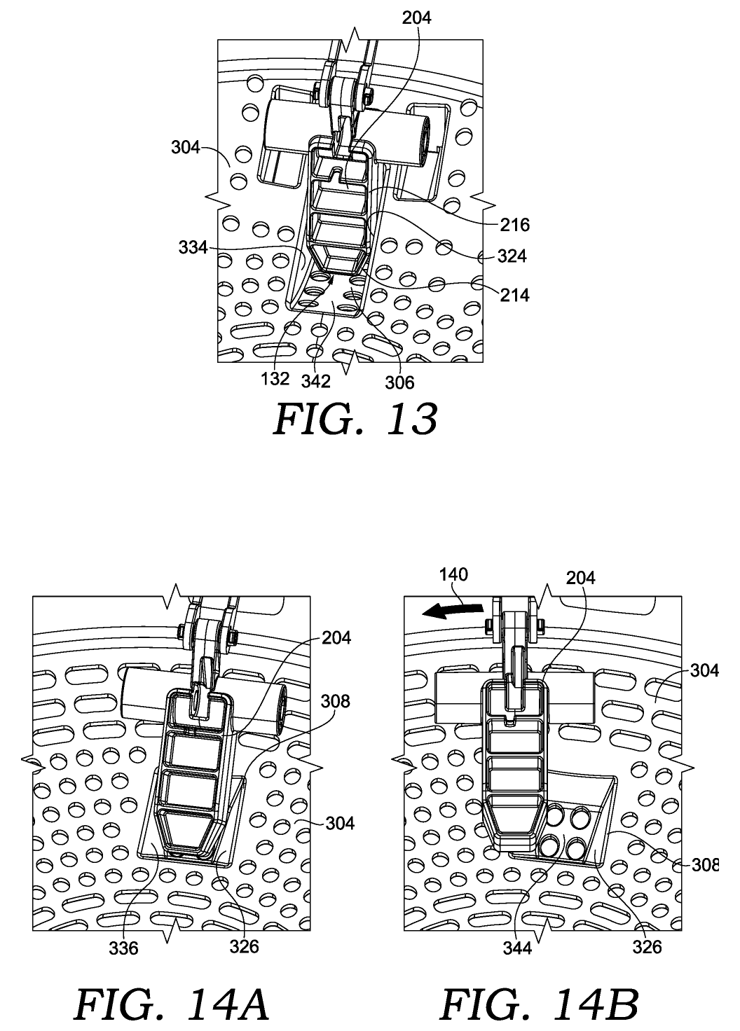

Moving on the FIG. 13, engagement of the rotation locking arm 204 with the primary positioning cavities 306 is provided. As shown, the primary positioning cavities 306 comprise the first side wall 324 and the opposing second side wall 334 along with the primary base surface 342 extending between the first side wall 324 and the second side wall 334. The first depth 338 of the primary positioning cavities 306 is such that the first portion 214 and the second portion 216 of the rotation locking arm 204 are contained within the side walls (e.g., the first side wall 324) of the primary positioning cavities 306. As such, the first depth 338 is greater than a length of the first portion 214. In aspects, the first depth 338 is at least two times as deep as the second depth 340. In an aspect, having the first depth 338 at least twice that of the second depth 340 provides for sufficient manufacturing tolerances and confidence of engagement of the locking arm 204 within the primary positioning cavity 306 to lock rotational movement. Because both the first portion 214 (distal portion) and the second portion 216 (proximal portion) of the rotation locking arm 204 are contained within the side walls of the primary positioning cavities 306, the rotation locking arm 204 is “locked” within the primary positioning cavities 306 such that actuation of a handle (or any other mechanism to activate movement of the rotation locking arm 204) is required in order to release the rotation locking arm 204 from the primary positioning cavities 306. In other words, rotation locking arm 204 extends into the primary positioning cavities 306 a sufficient depth so that at least the second portion 216 of the rotation locking arm 204 mechanically interferes with the side walls of the primary positioning cavities 306.

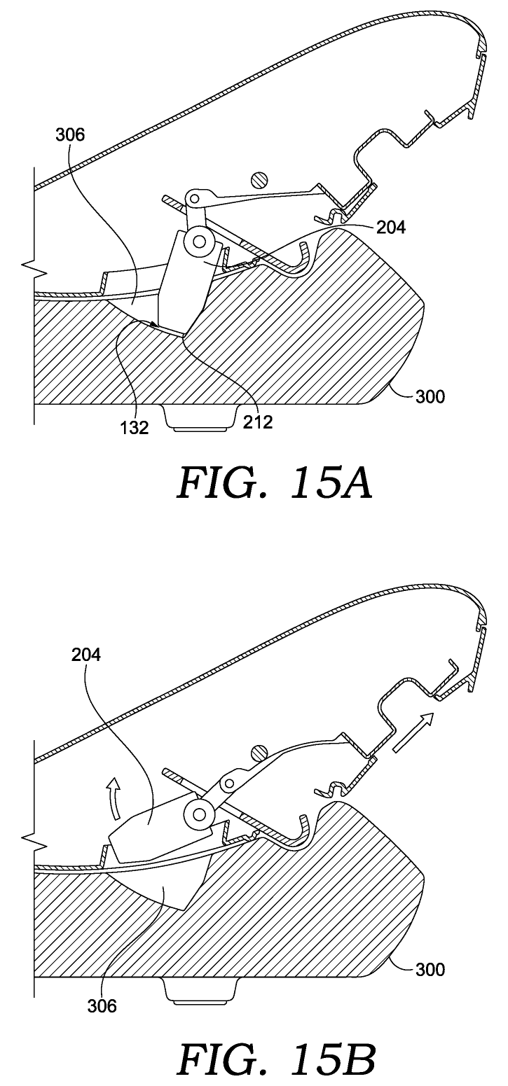

This engagement is also provided in FIGS. 15A and 15B, which are cross-sectional views of the rotation locking arm 204 within the primary positioning cavity 306 of the base 300 and being released from the primary positioning cavity 306. As shown, both the first portion 214 and the second portion 216 of the rotation locking arm 204 are contained within the side walls (i.e., the rotation locking arm 204 extends into the primary positioning cavity 306 at a depth such that both the first portion 214 and the second portion 216 are extended into the primary positioning cavity 306). Also shown is a gap 132 between the distal end 212 of the rotation locking arm 204 and the primary base surface 342 such that the distal end 212 does not engage with the primary base surface 342.

In contrast, FIGS. 14A and 14B illustrate engagement of the rotation locking arm 204 with the secondary positioning cavities 308 having a lesser depth than the primary positioning cavities 306 and lesser angles between the side walls of the secondary positioning cavities 308 and the receiving cavity surface 304. FIG. 14A illustrates the rotation locking arm 204 within the secondary positioning cavity 308 while FIG. 14B illustrates the rotation locking arm 204 being moved from the secondary positioning cavity 308 in a rotational direction illustrated by directional arrow 140. FIG. 14A also illustrates that the first portion 214 of the rotation locking arm 204 engages with the side wall (e.g., first side wall 326) of the secondary positioning cavity 308. In aspects, the second portion 216 of the rotation locking arm 204 does not engage with side walls (e.g., first side wall 326 or second side wall 336) of the secondary positioning cavities 308. In aspects, the second depth 340 is equal to or less than a length of the first portion 214, where the length of the first portion 214 extends from the distal end 212 to the second portion 216. In other aspects, the second depth 340 is greater than the length of the first portion 214 but less than a length of both the first portion 214 and the second portion 216.

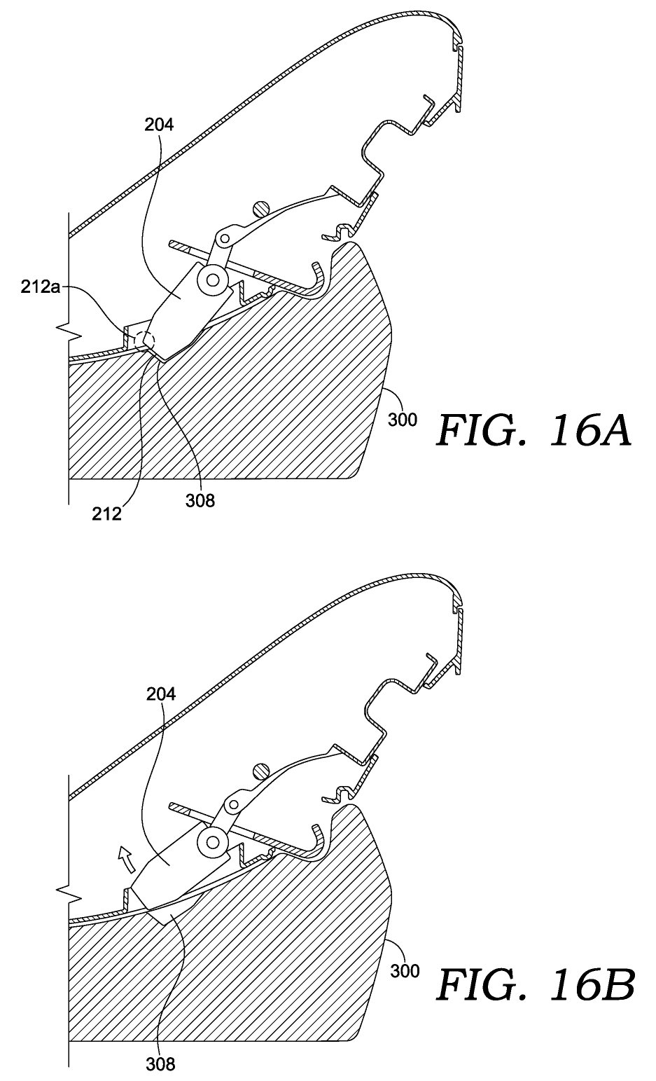

Exemplary cross-section views are also provided by way of FIGS. 16A and 16B. FIG. 16A provides the rotation locking arm 204 having the first portion 214 engaged with the side walls (e.g., first side wall 326 or second side wall 336). There is a portion 212a of the distal end 212 that does not fit within or engage with the secondary positioning cavities 308. This allows for easy rotation of the rotation locking arm 204 out of the secondary positioning cavities 308 without actuation of a handle or other release mechanism to move the rotation locking arm 204. Rather, external rotational force of a user is sufficient to move the rotation locking arm 204 out of the secondary positioning cavities 308 due to the shallower depth and the greater angles of the side walls relative to the receiving cavity surface 304.

In certain constructions, the base 300 may include one or more indicators configured to indicate whether rotation of the seat shell 200 is locked with respect to the base 300. In aspects, a first indicator may be positioned on the first side 314 of the base 300. Similarly, a second indicator may be positioned on the opposite, second side 316 of the base 300. Each of the first and second indicators may be configured to indicate whether rotation of the seat shell 200 is locked with respect to the base 300 (e.g., particularly to indicate whether rotation of the seat shell 200 is locked in the forward-facing position or the rearward-facing position). In particular, the first and second indicators may be configured to visibly indicate whether rotation of the seat shell 200 is locked with respect to the base 300. By way of non-limiting example, the first and second indicators may be configured to give a visual indication in a first color (e.g., red) when rotation of the seat shell 200 is unlocked with respect to the base 300 and/or when the seat shell 200 is not in the forward-facing position or the rearward-facing position, and the first and second indicators may be configured to give a visual indication in a second, different color (e.g., green) when rotation of the seat shell 200 is locked with respect to the base 300 and/or when the seat shell 200 is in the forward-facing position or the rearward-facing position. Put another way, when the rotation locking arm 204 is confined within one of the first primary positioning cavity 306a or the second primary positioning cavity 306, the indicators may indicate that the seat shell 200 is locked with respect to the base 300. In contrast, when the rotation locking arm 204 is confined within one of the first secondary positioning cavity 308a or the second secondary positioning cavity 308b, the indicators may indicate that the seat shell 200 is not locked with respect to the base 300 (e.g., rotation of the seat shell 200 is unlocked).

It should be noted that some of the terms used herein may be relative terms. For example, the terms “upper” and “lower” and the terms “forward” (or “front”) and “rearward” (or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e. the surface of the earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and do not necessarily require that such components contact one another (directly or indirectly). As used herein and as will be appreciated by those skilled in the art, the term “car seat” encompasses car seats, safety seats, restraints, boosters, and the like for children, infants, toddlers, and the like.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1: A car seat comprising: a seat shell having a bottom surface and a rotation locking arm extending from the bottom surface; and a base having a receiving portion, wherein the receiving portion comprises a receiving cavity surface configured to interface with the seat shell bottom surface, wherein the receiving portion further comprises a first primary positioning cavity and a first secondary positioning cavity extending through the receiving cavity surface into the receiving portion, wherein the first primary positioning cavity has a first side wall having a first angle relative to the receiving cavity surface and the first secondary positioning cavity has a first side wall having a second angle relative to the receiving cavity surface, and wherein the second angle is less than the first angle.

Clause 2: The car seat of clause 1, wherein the rotation locking arm has a first side, a second side, and a distal end extending between the first side and the second side, and wherein the rotation locking arm has a first portion and a second portion, wherein the first portion extends from the distal end to the second portion.

Clause 3: The car seat of any of clauses 1-2, wherein the first portion of the locking arm is configured to engage with the first side wall of the first secondary positioning cavity, and wherein the second portion of the locking arm is configured to engage with the first side wall of the first primary positioning cavity.

Clause 4: The car seat of any of clauses 1-2, wherein the first side and the second side of the rotation locking arm converge in the first portion, and wherein the first side and the second side of the rotation locking arm are parallel in the second portion.

Clause 5: The car seat of any of clauses 1-4, the base having a rotational axis extending through the receiving portion about which the seat shell rotates.

Clause 6: The car seat of clause 5, wherein the first primary positioning cavity is at a first radial extending from the rotational axis and the first secondary positioning cavity is at a second radial extending from the rotational axis.

Clause 7: The car seat of clause 6, wherein the first radial and second radial are offset 90 degrees.

Clause 8: The car seat of clause 6, wherein the first radial extends through a midline of a front side.

Clause 9: The car seat of any one of clauses 1-8, wherein the receiving portion further comprises a second primary positioning cavity and a second secondary positioning cavity.

Clause 10: The car seat of clause 9, wherein the first primary positioning cavity and the second primary positioning cavity are offset 180 degrees from each other relative to a rotational axis, and wherein the first secondary positioning cavity and the second secondary positioning cavity are offset 180 degrees from each other relative to the rotational axis.

Clause 11: The car seat of clause 10, wherein the first secondary positioning cavity has a first side wall and an opposing second side wall, and wherein the first side wall is in a first rotational direction and the second side wall is in a second rotational direction.

Clause 12: The car seat of any one of clauses 1-11, wherein the first primary positioning cavity has the first side wall and an opposing second side wall, and wherein the first side wall is in a first rotational direction and the second side wall is in a second rotational direction.

Clause 13: The car seat of any one of clauses 1-12, wherein the first angle of the first side wall of the first primary positioning cavity relative to the receiving cavity surface is greater than 265 degrees.

Clause 14: The car seat of any one of clauses 1-13, wherein the second angle is less than 260 degrees.

Clause 15: The car seat of any one of clauses 1-14, wherein the first primary positioning cavity and the first secondary positioning cavity pass through a first radial extending from a rotational axis.

Clause 16: A car seat comprising: a seat shell having a bottom surface and a rotation locking arm extending from the bottom surface; and a base having a receiving portion, wherein the receiving portion comprises a receiving cavity surface configured to interface with the seat shell bottom surface, further comprising a first primary positioning cavity and a first secondary positioning cavity extending through the receiving cavity surface into the receiving portion, wherein the first primary positioning cavity extends a first depth into the receiving portion from the receiving cavity surface and the first secondary positioning cavity extends a second depth into the receiving portion from the receiving cavity surface, and wherein the first depth is greater than the second depth.

Clause 17: The car seat of clause 16, wherein the first primary positioning cavity has a base surface extending between a first side wall and a second side wall, wherein the first depth is measured from the base surface of the first primary positioning cavity to the receiving cavity surface, and wherein the first secondary positioning cavity has a base surface extending between a first side wall and a second side wall, and wherein the second depth is measured from the base surface of the first secondary positioning cavity to the receiving cavity surface.

Clause 18: The car seat of any one of clauses 16-17, the base having a rotational axis extending through the receiving portion about which the seat shell rotates.

Clause 19: A car seat comprising: a seat shell having a bottom surface and a rotation locking arm extending from the bottom surface; and a base having a receiving portion, wherein the receiving portion comprises a receiving cavity surface configured to interface with the seat shell bottom surface, further comprising a first primary positioning cavity and a first secondary positioning cavity extending through the receiving cavity surface into the receiving portion, wherein the first primary positioning cavity has a first side wall having a first angle relative to the receiving cavity surface and the first secondary positioning cavity has a first side wall having a second angle relative to the receiving cavity surface, and wherein the second angle is less than the first angle, and wherein the first primary positioning cavity extends a first depth into the receiving portion from the receiving cavity surface and the first secondary positioning cavity extends a second depth into the receiving portion from the receiving cavity surface, and wherein the first depth is greater than the second depth.

Clause 20: The car seat of clause 19, the base having a rotational axis extending through the receiving portion about which the seat shell rotates.

While particular exemplary embodiments have been described, it is not intended that the claims be limited thereto, as it is intended that the claims be as broad in scope as the art will allow and that the specification be read likewise. That is, the foregoing description of specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps and materials illustrated above may be varied by substitution of equivalent components, steps and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A car seat comprising:
a seat shell having a bottom surface and a rotation locking arm extending from the bottom surface; and
a base having a receiving portion, wherein the receiving portion comprises a receiving cavity surface configured to interface with the seat shell bottom surface, wherein the receiving portion further comprises a first primary positioning cavity and a first secondary positioning cavity extending through the receiving cavity surface into the receiving portion,
wherein the first primary positioning cavity has a first side wall having a first angle relative to the receiving cavity surface and the first secondary positioning cavity has a first side wall having a second angle relative to the receiving cavity surface, and wherein the second angle is less than the first angle.

2. The car seat of claim 1, wherein the rotation locking arm has a first side, a second side, and a distal end extending between the first side and the second side, and wherein the rotation locking arm has a first portion and a second portion, wherein the first portion extends from the distal end to the second portion.

3. The car seat of claim 2, wherein the first portion of the locking arm is configured to engage with the first side wall of the first secondary positioning cavity, and wherein the second portion of the locking arm is configured to engage with the first side wall of the first primary positioning cavity.

4. The car seat of claim 2, wherein the first side and the second side of the rotation locking arm converge in the first portion, and wherein the first side and the second side of the rotation locking arm are parallel in the second portion.

5. The car seat of claim 1, the base having a rotational axis extending through the receiving portion about which the seat shell rotates.

6. The car seat of claim 5, wherein the first primary positioning cavity is at a first radial extending from the rotational axis and the first secondary positioning cavity is at a second radial extending from the rotational axis.

7. The car seat of claim 6, wherein the first radial and second radial are offset 90 degrees.

8. The car seat of claim 6, wherein the first radial extends through a midline of a front side.

9. The car seat of claim 1, wherein the receiving portion further comprises a second primary positioning cavity and a second secondary positioning cavity.

10. The car seat of claim 9, wherein the first primary positioning cavity and the second primary positioning cavity are offset 180 degrees from each other relative to a rotational axis, and wherein the first secondary positioning cavity and the second secondary positioning cavity are offset 180 degrees from each other relative to the rotational axis.

11. The car seat of claim 10, wherein the first secondary positioning cavity has a first side wall and an opposing second side wall, and wherein the first side wall is in a first rotational direction and the second side wall is in a second rotational direction.

12. The car seat of claim 1, wherein the first primary positioning cavity has the first side wall and an opposing second side wall, and wherein the first side wall is in a first rotational direction and the second side wall is in a second rotational direction.

13. The car seat of claim 1, wherein the first angle of the first side wall of the first primary positioning cavity relative to the receiving cavity surface is greater than 265 degrees.

14. The car seat of claim 1, wherein the second angle is less than 260 degrees.

15. The car seat of claim 1, wherein the first primary positioning cavity and the first secondary positioning cavity pass through a first radial extending from a rotational axis.

16. A car seat comprising:
a seat shell having a bottom surface and a rotation locking arm extending from the bottom surface; and
a base having a receiving portion, wherein the receiving portion comprises a receiving cavity surface configured to interface with the seat shell bottom surface, further comprising a first primary positioning cavity and a first secondary positioning cavity extending through the receiving cavity surface into the receiving portion,
wherein the first primary positioning cavity extends a first depth into the receiving portion from the receiving cavity surface and the first secondary positioning cavity extends a second depth into the receiving portion from the receiving cavity surface, and wherein the first depth is greater than the second depth.

17. The car seat of claim 16, wherein the first primary positioning cavity has a base surface extending between a first side wall and a second side wall, wherein the first depth is measured from the base surface of the first primary positioning cavity to the receiving cavity surface, and
wherein the first secondary positioning cavity has a base surface extending between a first side wall and a second side wall, and wherein the second depth is measured from the base surface of the first secondary positioning cavity to the receiving cavity surface.

18. The car seat of claim 16, the base having a rotational axis extending through the receiving portion about which the seat shell rotates.

19. A car seat comprising:
a seat shell having a bottom surface and a rotation locking arm extending from the bottom surface; and
a base having a receiving portion, wherein the receiving portion comprises a receiving cavity surface configured to interface with the seat shell bottom surface, further comprising a first primary positioning cavity and a first secondary positioning cavity extending through the receiving cavity surface into the receiving portion,
wherein the first primary positioning cavity has a first side wall having a first angle relative to the receiving cavity surface and the first secondary positioning cavity has a first side wall having a second angle relative to the receiving cavity surface, and wherein the second angle is less than the first angle, and
wherein the first primary positioning cavity extends a first depth into the receiving portion from the receiving cavity surface and the first secondary positioning cavity extends a second depth into the receiving portion from the receiving cavity surface, and wherein the first depth is greater than the second depth.

20. The car seat of claim 19, the base having a rotational axis extending through the receiving portion about which the seat shell rotates.
